(19) United States
(12) Patent Application Publication
(10) Pub. No.: US 2024/0408784 A1
(43) Pub. Date: Dec. 12, 2024

(54) PUNCHING DIE AND PUNCHING MACHINE

(71) Applicant: SDS JAPAN CO., LTD., Saitama (JP)

(72) Inventor: IN BAE JUNG, SAITAMA (JP)

(21) Appl. No.: 18/699,534

(22) PCT Filed: Nov. 17, 2021
(86) PCT No.: PCT/JP2021/042215

§ 371 Date: Apr. 8, 2024

(51) Int. Cl. B26F 1/44

(52) U.S. Cl. CPC B26F 1/44; B26F 2001/4436

(57) ABSTRACT

The present invention can simplify the work for forming a punching die, enables stable support of blade members, enables improvement of punching accuracy, and enables enhancement of durability. A plurality of wood molded boards are formed by performing a thermo-pressure process on wood chips at a predetermined temperature and under a predetermined pressure. A die substrate is formed by stacking the molded boards and bonding them together by means of adhesive. Blade members are press-fitted into grooves formed in the die substrate by means of laser machining such that the groove penetrates through the die substrate. The densities of near-surface regions composed of regions located near opposite surfaces of the die substrate and a density of a central region composed of regions located adjacent to each other with the adhesive intervening therebetween are higher than the densities of intermediate regions located between the near-surface regions and the central region.

### TECHNICAL FIELD

The present invention relates to a punching die and a punching machine.

### BACKGROUND ART

Conventionally, a container formed of a sheet material, such as paper board, corrugated board, or the like, is formed by punching out a sheet material by a punching machine to form a blank and bending the blank at predetermined positions.

Therefore, the punching machine has an upper platen and a lower platen. A punching die is attached to the upper platen, and a cutting plate is attached to the lower platen. A sheet material is placed on the cutting plate, and the upper platen is lowered and pressed against the lower platen. As a result, the sheet material is punched out, so that a blank having a shape corresponding to the structure of a container is formed, and rules for bending are formed on the blank.

Grooves having predetermined patterns are formed in a die substrate of the punching die, and various types of punching blades for punching out the sheet material and various types of rule-forming blades for forming rules for bending on the sheet material are embedded in the grooves. The punching blades have sharp cutting edges, and the rule-forming blades have rounded cutting edges.

In the punching die, cushion members formed of an elastic material are bonded to the die substrate of the punching die to be located on opposite sides of each punching blade such that the cushion members extend along the punching blade.

FIG. 2 is a view showing a die opened state of a conventional punching machine, FIG. 3 is a plan view of a conventional punching die, and FIG. 4 is a view showing a die closed state of the conventional punching machine.

In these drawings, 10 denotes a punching machine, 11 denotes a lower platen, and 12 denotes an upper platen disposed to be movable in the vertical direction in relation to the lower platen 11. The lower platen 11 includes a support platen 14, and a cutting plate 15 attached to the support platen 14. The upper platen 12 includes a support platen 16, and a punching die 17 attached to the support platen 16.

The punching die 17 includes a die substrate 22, punching blades 24 which are disposed along the peripheries of blanks and used for punching out a sheet material 18 placed on the cutting plate 15, rule-forming blades 25 for forming rules for bending on a sheet material 18, cushion members 28 disposed on opposite sides of each punching blade 24 such that the cushion members 28 extend along the punching blade 24.

The die substrate 22 is formed by stacking a plurality of plates cut from raw wood and bonding the plates together. The blade members (i.e., the punching blades 24 and the rule-forming blades 25) are embedded in grooves m1 formed in the die substrate 22 by means of laser machining to have a predetermined depth. The cushion members 28 are formed of an elastic material and bonded to the die substrate 22 at predetermined positions on opposite sides of each punching blade 24. The heights of the cushion members 28 are set such that, in a die opened state of the punching machine 10, the top surfaces of the cushion members 28 are located higher than the cutting edge 24a of the punching blade 24.

In a die opened state of the punching machine 10, as shown in FIG. 2, the upper platen 12 is positioned at an upper position, whereby a gap is formed between the upper platen 12 and the lower platen 11. In this state, the sheet material 18 is placed at a predetermined position on the cutting plate 15.

In a die closed state of the punching machine 10, as shown in FIG. 4, the upper platen 12 is moved downward to a lower position and is pressed against the lower platen 11. As a result, the cushion members 28 are compressed, and the cutting edges 24a protrude from between the cushion members 28, thereby punching out the sheet material 18. Thus, blanks are formed. At that time, the cushion members 28 are pressed against the lower platen 11 via the sheet material 18, support the die substrate 22 from the lower side, and prevent the punching blade 24 from excessively moving downward. Also, rules are formed on the sheet material 18 by the cutting edges 25a of the rule-forming blades 25.

When the upper platen 12 is raised after the sheet material 18 has been punched out, the cushion members 28 extend, and the blanks are separated from the cutting edges 24a by restoration forces (i.e., repulsive forces) of the cushion members 28 at that time.

Incidentally, the conventional punching die 17 has the following problem. It is difficult to obtain raw wood used for forming the die substrate 22, and the raw wood is expensive. In addition, since the die substrate 22 must be formed by stacking a plurality of plates cut from the raw wood and bonding together, the cost of the punching die 17 is high.

In order to solve the above-described problem, a punching die 17 in which a molded board composed of a fiber board is used as a part of the die substrate 22 is provided.

FIG. 5 is a perspective view of a conventional die substrate, FIG. 6 is a first view used for describing a method for forming the conventional die substrate, FIG. 7 is a second view used for describing a method for forming the conventional die substrate, and FIG. 8 is a third view used for describing a method for forming the conventional die substrate.

In these drawings, 22 denotes a die substrate, P0 denotes a molded board, 26 denotes a core member formed by performing cutting on the molded board P0, and 27 denotes each of laminated surface members bonded to opposite sides of the core member 26.

In this case, since the molded board P0 is a fiber board which is formed by mixing fibers, obtained through cooking of raw material chips, with adhesive, and performing a thermo-pressure process on the resultant mixture, thereby forming the mixture into a plate shape, the density of the molded board P0 is high at the opposite surfaces thereof and decreases with the distance from the opposite surfaces. Accordingly, in the case where the punching die 17 is formed by embedding blade members into the grooves m1 of the die substrate 22, the die substrate 22 fails to stably support the blade members.

In view of the above, as shown in FIGS. 6 and 7, regions eg1 and eg2 near the opposite surfaces of the molded board P0 are cut and removed using a cutting tool such as a sander 31 so as to form a core member 26, and laminated surface members 27 are bonded to the opposite surfaces of the core member 26 by using adhesive.

Each of the laminated surface members 27 is formed by bonding together a plurality of wood veneers, for example, three wood veneers gi (i=1, 2, 3) by using adhesive, thereby forming a laminate, and applying heat and pressure to the laminate (see, for example, Patent Document 1). Notably, wood veneers are thin plates cut from raw wood.

### PRIOR ART DOCUMENT

### Patent Document

Patent Document 1: Japanese Patent No. 224125

### SUMMARY OF THE INVENTION

### Problem to be Solved by the Invention

However, in the conventional die substrate 22, each laminated surface member 27 is formed by stacking the wood veneers gi, and the wood veneers gi must be stacked such that their grains are orthogonal to one another. Therefore, the work of forming the punching die 17 is troublesome, and the cost of the punching die 17 increases due to use of the wood veneers gi. Also, depending on the positions, shapes, etc. of the grains of the wood veneers gi, the surfaces of the die substrate 22; i.e., the laminated surface members 27 cannot have uniform strengths. Therefore, the die substrate 22 cannot stably support the blade members. In addition, as a result of repeated operation of punching out the sheet material 18, punching accuracy lowers, and the laminated surface members 27 may peel off from the core member 26. This means that the durability of the punching die 17 is low.

An object of the present invention is to provide a punching die and a punching machine which solve the problems of the above-described conventional punching die 17 and which can simplify the work for forming the punching die, can stably support blade members, can increase punching accuracy, and can enhance durability.

### Means for Solving the Problem

In order to achieve the object, a punching die of the present invention comprises: a plurality of wood molded boards each formed by performing a thermo-pressure process on wood chips at a predetermined temperature and under a predetermined pressure; adhesive disposed between the stacked molded boards for bonding together to compose a die substrate; and a blade member press-fitted into a groove formed in the die substrate by means of laser machining such that the groove penetrates through the die substrate.

In the die substrate, the densities of near-surface regions composed of regions located near opposite surfaces of the die substrate and a density of a central region composed of regions located adjacent to each other with the adhesive intervening therebetween are higher than the densities of intermediate regions located between the near-surface regions and the central region.

### Effects of the Invention

According to the present invention, the punching die comprises: a plurality of wood molded boards each formed by performing a thermo-pressure process on wood chips at a predetermined temperature and under a predetermined pressure; adhesive disposed between the stacked molded boards for bonding together to compose a die substrate; and a blade member press-fitted into a groove formed in the die substrate by means of laser machining such that the groove penetrates through the die substrate.

In the die substrate, the densities of near-surface regions composed of regions located near opposite surfaces of the die substrate and a density of a central region composed of regions located adjacent to each other with the adhesive intervening therebetween are higher than the densities of intermediate regions located between the near-surface regions and the central region.

In this case, since the die substrate is formed by merely stacking a plurality of molded boards and bonding them together by using adhesive, the work for forming the punching die can be simplified.

Since no wood veneers are used for the die substrate, the die substrate can have uniform surface strength and can stably support the blade member. In addition, even when the operation of punching out a sheet material is repeated, punching accuracy does not lower. Therefore, the durability of the punching die can be enhanced.

Since the densities of the near-surface regions and the central region of the die substrate are rendered higher than the densities of the intermediate regions, when the blade member is embedded in the groove, thereby forming the punching die, the blade member is supported by three regions whose densities are high; i.e., the near-surface regions and the central region of the die substrate. Therefore, the blade member can be more stably supported.

Furthermore, since the blade member is supported by three regions whose densities are high, even when external forces act on the blade member as a result of repeated operation of punching out the sheet material, wood fibers having burned and charred are not compressed by the blade member in the intermediate regions, and no gaps are formed between the blade member and the wall surfaces of the groove. Thus, the blade member can be reliably supported. Therefore, the cutting edge of the blade member does not wobble, and thus, it is possible to stably punch out the sheet material and stably form rules on the sheet material. As a result, punching accuracy can be improved.

### BRIEF DESCRIPTION OF THE DRAWINGS

FIG. 1 Sectional view of a main portion of a die substrate in an embodiment of the present invention.

FIG. 2 View showing a die opened state of a conventional punching machine.

FIG. 3 Plan view of a conventional punching die.

FIG. 4 View showing a die closed state of the conventional punching machine.

FIG. 5 Perspective view of a conventional die substrate.

FIG. 6 First view used for describing a method for forming the conventional die substrate.

FIG. 7 Second view used for describing the method for forming the conventional die substrate.

FIG. 8 Third view used for describing the method for forming the conventional die substrate.

FIG. 9 View showing a die opened state of a punching machine in the embodiment of the present invention.

FIG. 10 View showing a die closed state of the punching machine in the embodiment of the present invention.

FIG. 11 View showing a state in which adhesive has been applied to a molded board in the embodiment of the present invention.

FIG. 12 View showing a state in which grooves have been formed in a die substrate in the embodiment of the present invention.

FIG. 13 Sectional view of a main portion of a punching die in the embodiment of the present invention.

FIG. 14 Graph showing an example of the density distribution of a molded board.

FIG. 15 Graph showing an example of the density distribution of the die substrate in the embodiment of the present invention.

FIG. 16 Picture obtained by photographing a cross section of a single molded board in which grooves have been formed by means of laser machining.

FIG. 17 Picture obtained by photographing a cross section of the die substrate in the embodiment of the present invention in which grooves have been formed by means of laser machining.

### MODES FOR CARRYING OUT THE INVENTION

An embodiment of the present invention will now be described in detail with reference to the drawings.

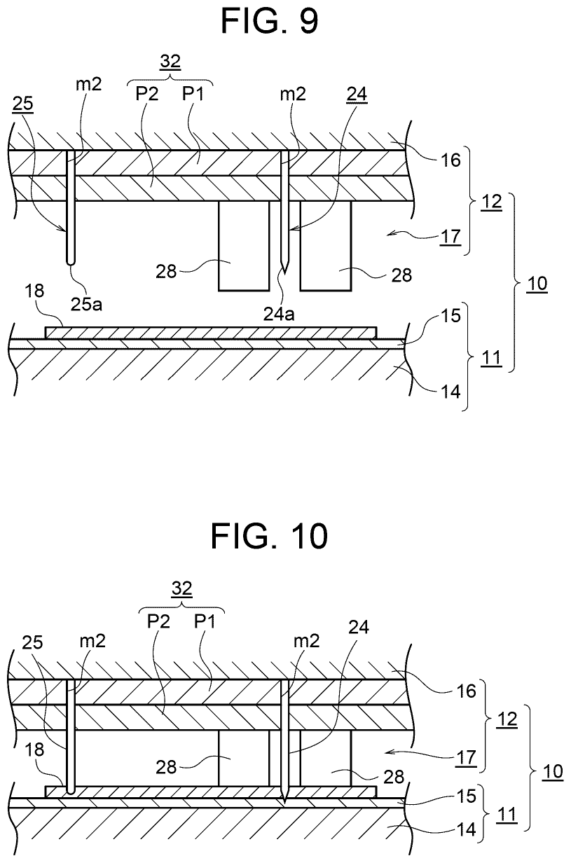

FIG. 9 is a view showing a die opened state of a punching machine in the embodiment of the present invention, and FIG. 10 is a view showing a die closed state of the punching machine in the embodiment of the present invention.

In these drawings, 10 denotes a punching machine, 11 denotes a lower platen, and 12 denotes an upper platen disposed to be movable in the vertical direction in relation to the lower platen 11. The lower platen 11 includes a support platen 14 and a cutting plate 15 attached to the support platen 14. The upper platen 12 includes a support platen 16 and a punching die 17 attached to the support platen 16.

The punching die 17 includes a die substrate 32, punching blades 24 which are disposed along the peripheries of blanks and used for punching out a sheet material 18 placed on the cutting plate 15, rule-forming blades 25 for forming rules for bending on the sheet material 18, cushion members 28 disposed on opposite sides of each punching blade 24 such that the cushion members 28 extend along the punching blade 24. The punching blades 24 and the rule-forming blades 25 constitute blade members.

The blade members are embedded in grooves m2 formed in the die substrate 32 by means of laser machining such that the grooves m2 penetrate through the die substrate 32.

The cushion members 28 are formed of an elastic material and bonded to the die substrate 32 at predetermined positions on opposite sides of each punching blade 24. The heights of the cushion members 28 are set such that, in a die opened state of the punching machine 10, the top surfaces of the cushion members 28 are located higher than the cutting edge 24a of the punching blade 24.

In a die opened state of the punching machine 10, as shown in FIG. 9, the upper platen 12 is positioned at an upper position, whereby a gap is formed between the upper platen 12 and the lower platen 11. In this state, a sheet material 18 is placed at a predetermined position on the cutting plate 15.

In a die closed state of the punching machine 10, as shown in FIG. 10, the upper platen 12 is moved downward to a lower position and is pressed against the lower platen 11. Thus, the cushion members 28 are compressed, and the cutting edges 24a protrude from between the cushion members 28, thereby punching out the sheet material 18. As a result, blanks are formed. At that time, the cushion members 28 are pressed against the lower platen 11 via the sheet material 18, support the die substrate 22 from the lower side, and prevent the punching blade 24 from excessively moving downward. Also, rules are formed on the sheet material 18 by the cutting edges 25a of the rule-forming blades 25.

When the upper platen 12 is raised after the sheet material 18 has been punched out, the cushion members 28 extend, and the blanks are separated from the cutting edges 24a by restoration forces (i.e., repulsive forces) of the cushion members 28 at that time.

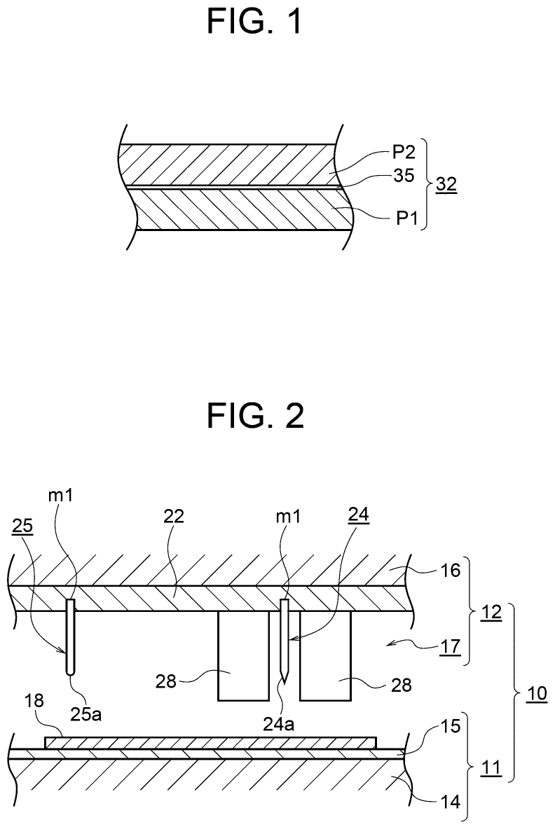

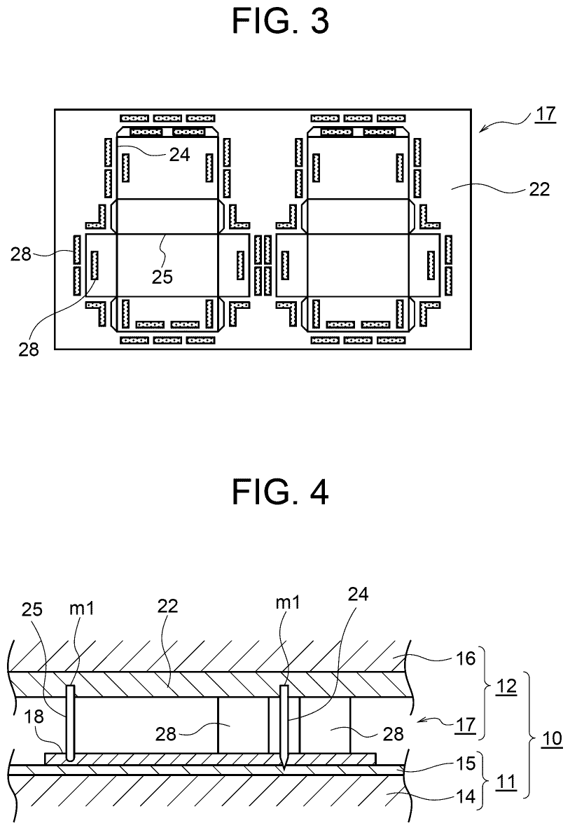

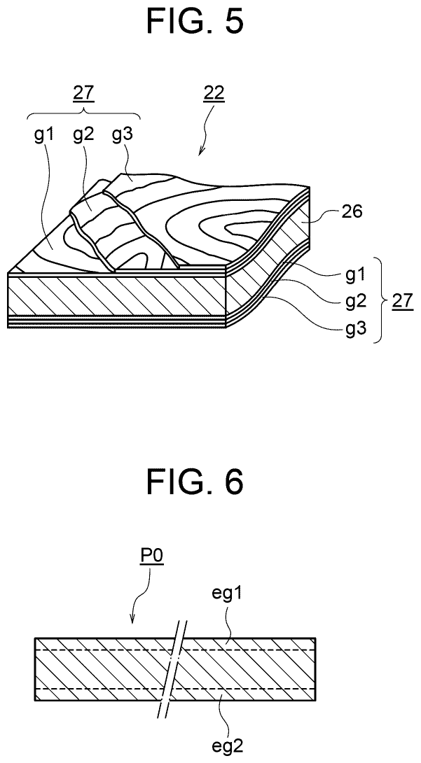

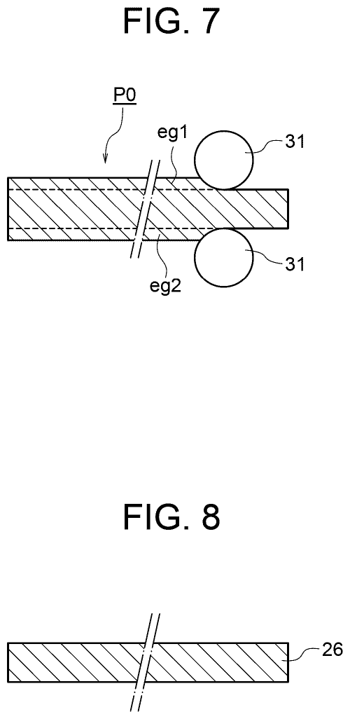

The die substrate 32 is composed of a plurality of (two in the present embodiment) rectangular molded boards Pj (j=1, 2) which are fiber boards and bonded together by using adhesive 35 for boards (FIG. 1), which will be described later.

Each molded board Pj is a medium density fiber board (hereinafter referred to as “MDF”) which is formed by mixing together wood fibers (80 to 90%), adhesive formed of melamine-urea-formaldehyde resin (10 to 20%), emulsion of wax (0.5 to 2.0%), drying the resultant mixture, and then performing a thermo-pressure process at a temperature of 240° C. under a pressure of 50 bar so as to form the resultant mixture into a plate shape. The wood fibers are obtained through cooking of chips of raw wood (in the present embodiment, pine (Korean pine)). The formed medium density fiber board has a density equal to or greater than 350 kg/m³ and less than 850 kg/m³ as determined in accordance with Japanese industrial standard “A5905 2014.”

The adhesive 35 is a foaming adhesive (EVF-50(S), manufactured by Ewon Industry Corporation) which contains limestone in an amount of 1 to 10%, EVA (ethylene vinyl acetate copolymer) in an amount of 80 to 85%, and water in an amount of 10 to 15% and which is higher in water resistance, heat resistance, and elasticity than polyethylene.

Next, the punching die 17 will be described.

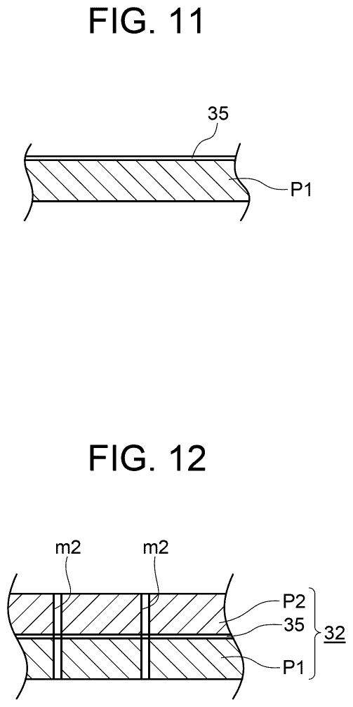

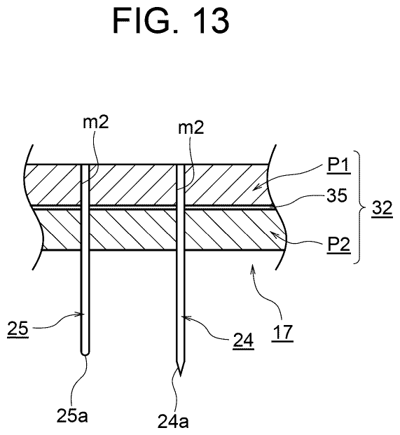

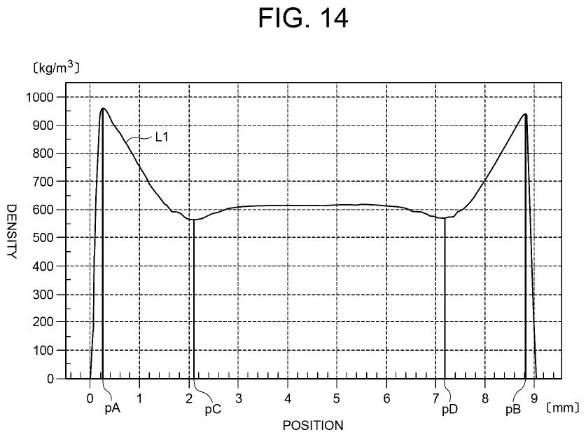

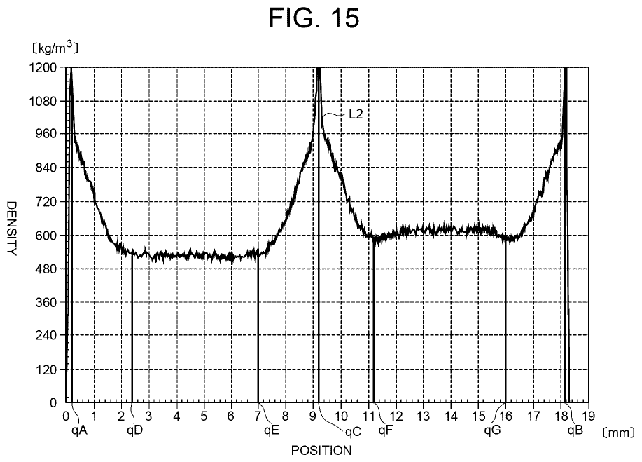

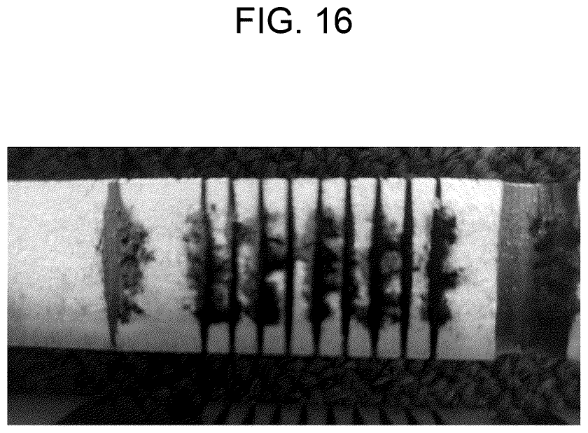

FIG. 1 is a sectional view of a main portion of the die substrate in the embodiment of the present invention, FIG. 11 is a view showing a state in which adhesive has been applied to the molded board in the embodiment of the present invention, FIG. 12 is a view showing a state in which grooves have been formed in the die substrate in the embodiment of the present invention, FIG. 13 is a sectional view of a main portion of the punching die in the embodiment of the present invention, FIG. 14 is a graph showing an example of the density distribution of a molded board, and FIG. 15 is a graph showing an example of the density distribution of the die substrate in the embodiment of the present invention. Notably, in FIG. 14, the horizontal axis shows the position in the thickness direction of the molded board Pj, and the vertical axis shows the density of the molded board Pj, and in FIG. 15, the horizontal axis shows the position in the thickness direction of the die substrate 32, and the vertical axis shows the density of the die substrate 32.

The punching die 17 is manufactured as follows. First, as shown in FIG. 11, adhesive 35 is applied to a first molded board P1 which is composed of an MDF having a predetermined thickness (9 mm in the present embodiment).

Next, as shown in FIG. 1, a second molded board P2 which is composed of an MDF having a predetermined thickness (9 mm in the present embodiment) is stacked on the side of the molded board P1 where the adhesive 35 has been applied. The molded boards P1 and P2 are bonded together by the adhesive 35, whereby the die substrate 32 composed of the two molded boards Pj and the adhesive 35 is formed.

Subsequently, as shown in FIG. 12, groove m2 are formed to penetrate through the die substrate 32 by means of laser machining such that the grooves m2 extend from one surface of the die substrate 32 to the other surface of the die substrate 32.

In the present embodiment, since the blade members composed of the punching blades 24 and the rule-forming blades 25 are embedded in the grooves m2 in such a manner that the blade members extend between the opposite surfaces of the die substrate 32, the grooves m2 are formed to penetrate through the die substrate 32.

Next, the blade members are embedded in the grooves m2 in such a manner that the blade members protrude from the surface on the molded board P2 side, and the above-mentioned cushion members 28 are bonded to the molded board P2 at predetermined positions on the opposite sides of each punching blade 24.

In this manner, the punching die 17 as shown in FIG. 13 is formed.

Notably, in order to prevent the blade members from coming off from the die substrate 32, the width of the grooves m2 is rendered slightly smaller than the thickness of the blade members, and the blade members are embedded in the groves m2 by means of press fitting.

At least the surface of the die substrate 32 on which the cushion members 28 are disposed or both the opposite surfaces of the die substrate 32 are covered by a surface member formed of resin (e.g., polypropylene). Accordingly, it is possible to prevent peeling off of the cushion member 28 from the die substrate 32, smoothly perform laser machining, and enhance the water resistance of the die substrate 32. Notably, it is possible to cover the cushion member 28 with paint having the same function as polypropylene or a surface member formed of a plate material.

Incidentally, in the present embodiment, the die substrate 32 is formed by bonding the two molded boards P1 and P2 together by using the adhesive 35. Therefore, if the thermal expansion coefficients of the molded boards P1 and P2 differ from the thermal expansion coefficient of the adhesive 35, when heat generated at the time of formation of the grooves m2 by means of laser machining is transferred to the adhesive 35, stains occur between the molded boards P1 and P2 and the adhesive 35 and the molded boards P1 and P2 may separate from each other.

In the present embodiment, since a foaming adhesive which is high in heat resistance and elasticity is used as the adhesive 35, even when the heat generated due to laser machining is transferred to the adhesive 35, no strain is generated between the molded boards P1 and P2 and the adhesive 35. Therefore, the molded boards P1 and P2 do not separate from each other, and, thus, the durability of the die substrate 32 can be enhanced.

In the present embodiment, since an adhesive which is high in water resistance is used as the adhesive 35, it is possible to prevent moisture around the die substrate 32 from penetrating to a bonding portion of each molded board Pj through the adhesive 35. Accordingly, it is possible to prevent each molded board Pj from curving due to moisture. Therefore, the blade members do not incline locally, and the molded boards P1 and P2 do not peel off from each other. As a result, the durability of the die substrate 32 can be enhanced.

Incidentally, the above-mentioned molded board Pj is formed by mixing together wood fibers, adhesive, and wax, drying the resultant mixture, and performing a thermo-pressure process on the resultant mixture. Therefore, the density changes in the thickness direction of the molded board Pj.

When the densities of various portions of a single molded board Pj having a thickness of 9 mm, for example, the molded board P1, are measured by using a density meter (“DPX” manufactured by IMAL Corporation), it is found that the density changes in the thickness direction of the molded board P1 as indicated by a line L1 of FIG. 14. Specifically, the density becomes almost the maximum at positions pA and pB near the opposite surfaces of the molded board P1, decreases linearly toward positions pC and pD, which are inwardly offset from the positions pA and pB by distances corresponding to about 20 to 25% of the thickness, and becomes almost the minimum between the positions pC and pD.

Namely, when the regions between the opposite surfaces of the molded board P1 and the positions pC and pD are defined as near-surface regions, and the region between the positions pC and pD is defined as an intermediate region, the density of the molded board P1 is high in the near-surface regions and is low in the intermediate region.

When the densities of various portions of the die substrate 32 composed of two molded boards Pj and the adhesive 35 are measured by using the above-mentioned density meter, it is found that the density changes in the thickness direction of the die substrate 32 as indicated by a line L2 of FIG. 15. Specifically, the density becomes almost the maximum at positions qA and qB near the opposite surfaces of the die substrate 32 and at a center position qC, decreases linearly toward positions qD, qE, qF, and qG, which are offset from the positions qA, qB and qC by distances corresponding to about 20 to 25% of the thickness, and becomes almost the minimum between the positions qD and qE and between the positions qF and qG.

Namely, when the regions between the opposite surfaces of the die substrate 32 and the positions qD and qG are defined as near-surface regions, the regions which are located between the positions qE and qF and are adjacent to each other with the adhesive 35 intervening therebetween are collectively defined as a central region, and the region between the position qD and qE and the region between the positions qF and qG (i.e., the regions between the near-surface regions and the central region) are defined as intermediate regions, the density of the die substrate 32 is high in the near-surface regions and the central region and is low in the intermediate regions.

Next, for the case where grooves m2 are formed in a single molded board Pj; for example, the molded board P1 and in the die substrate 32 by means of laser machining, there will be described the state in the molded board P1 and the state in the die substrate 32.

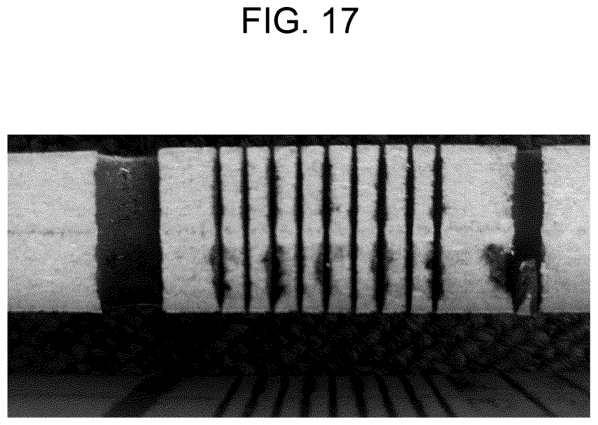

FIG. 16 is a picture obtained by photographing a cross section of a single molded board in which grooves have been formed by means of laser machining, and FIG. 17 is a picture obtained by photographing a cross section of the die substrate in the embodiment of the present invention in which grooves have been formed by means of laser machining.

In FIG. 16, a rectangular white region is the molded board P1, and 10 strip-shaped black regions extending vertically within the molded board P1 are the grooves m2 formed in the molded board P1 by means of laser machining. As shown in FIG. 16, each of the black regions representing the grooves m2 has a spindle-like shape. In the near-surface regions near the opposite surfaces of the molded board P1, each black region has a small width and does not penetrate into the white region, and the boundary between the black region and the white region is clear. In contrast, in the intermediate region between the near-surface regions, each black region has a large width and penetrates widely into the white region, and no boundary is observed between the black region and the white region.

Namely, when the grooves m2 are formed in the molded board P1 by means of laser machining, in the near-surface regions where the density of the molded board P1 is high, wood fibers do not burn and char, and the shapes of the grooves m2 are maintained. In contrast, in the intermediate region where the density of the molded board P1 is low, wood fibers in large regions around the grooves m2 burn and char, and the shapes of the grooves m2 cannot be maintained.

In FIG. 17, a rectangular white region is the die substrate 32 composed of two molded boards Pj, and 9 strip-shaped black regions extending vertically within the die substrate 32 are the grooves m2 formed in the die substrate 32 by means of laser machining. As shown in FIG. 17, each of the black regions representing the grooves m2 has two portions each having a spindle-like shape. In the near-surface regions and the central region of the die substrate 32, each black region has a small width and does not penetrate into the white region, and the boundary between the black region and the white region is clear. In contrast, in the intermediate regions of the die substrate 32, each black region has a large width and penetrates into the white region, and the boundary between the black region and the white region is unclear.

Namely, when the grooves m2 are formed in the die substrate 32 by means of laser machining, in the near-surface regions and the central region where the density of the molded board Pj constituting the die substrate 32 is high, wood fibers do not burn and char, and the shapes of the grooves m2 are maintained. In contrast, in the intermediate regions where the density of the molded board Pj is low, wood fibers around the grooves m2 burn and char, and the shapes of the grooves m2 are not maintained.

Therefore, in the case where the die substrate 32 is formed by using a single molded board P1 and the blade members are embedded in the grooves m2, thereby forming the punching die 17, as shown in FIG. 16, since the blade members are supported by only two regions; i.e., the near-surface regions of the molded board P1 and are not supported by the intermediate region of the molded board P1, the blade members cannot be stably supported.

In contrast, in the present embodiment, when the die substrate 32 is formed by using two molded boards Pj and the blade members are embedded in the grooves m2, thereby forming the punching die 17, as shown in FIG. 17, since the blade members are supported by three regions; i.e., the near-surface regions and the central region of the die substrate 32, the blade members can be stably supported.

Since the blade members are supported by three regions, even when external forces act on the blade members as a result of repeated operation of punching out the sheet material 18, in the intermediate regions, wood fibers having burned and charred are not compressed by the blade members, and no gaps are formed between the blade members and the wall surfaces of the grooves m2. Thus, the blade members can be reliably supported. Therefore, the cutting edges 24a and 25a do not wobble, and thus, it is possible to stably punch out the sheet material 18 and stably form rules on the sheet material 18. As a result, punching accuracy can be enhanced.

Incidentally, in the present embodiment, as described above, an MDF having a density equal to or greater than 350 kg/m³ and less than 850 kg/m³ as determined in accordance with the Japanese industrial standard “A5905 2014.” is used as the molded board Pj. The Japanese industrial standard “A5905 2014” provides that, in a test method for measuring the density of the molded board Pj, a specimen is collected not from the vicinity of the opposite surfaces of the molded board Pj but is collected from regions which are away from the opposite surfaces and where the density is uniform in the thickness direction. Accordingly, in the die substrate 32 of the present embodiment, an MDF in which both the density of the intermediate region between the positions qD and qE and the density of the intermediate region between the positions qF and qG are equal to or greater than 350 kg/m³ and less than 850 kg/m³ is used as the molded board Pj.

However, when the density of the intermediate region of each molded board Pj is increased, the densities in the near-surface regions and the central region become high, and the machining time needed to form the grooves m2 by means of laser machining becomes longer. In addition, in the near-surface regions and the central region, a larger amount of wood fibers burn and char around the grooves m2, and therefore, the grooves m2 fail to have proper widths and fail to stably support the blade members. When the density of the intermediate region of each molded board Pj is decreased, the densities in the near-surface regions and the central region become low, and, when the grooves m2 are formed by means of laser machining, the molded board Pj may be broken and damaged.

In view of the foregoing, an experiment was conducted in which die substrates 32 were formed by using molded boards Pj having different intermediate region densities, the sheet material 18 was punched out by using punching dies 17 including the die substrates 32, and there was determined a proper range for the densities between the positions qD and qE and between the positions qF and qG, within which range the grooves m2 can have proper widths and can stably support the blade members, and the molded board Pj is not broken and damaged.

As a result, it was found that, when the intermediate region density is set to fall in the range of 460 kg/m³ to 720 kg/m³, inclusive, preferably in the range of 520 kg/m³ to 650 kg/m³, inclusive, the grooves m2 can have proper widths and can stably support the blade members, and the molded board Pj is not broken and damaged.

In the present embodiment, since the die substrate 32 is formed by merely stacking the plurality of molded boards Pj and bonding them together by using the adhesive 35, the work for forming the punching die 17 can be simplified.

Since the wood veneers gi are not used for the die substrate 32, the die substrate can have uniform surface strength and can stably support the blade members. In addition, even when the operation of punching out the sheet material 18 is repeated, punching accuracy does not lower. As a result, the durability of the punching die 17 can be enhanced.

Since the densities of the near-surface regions and the central region of the die substrate 32 are rendered higher than the densities of the intermediate regions, when the blade members are embedded in the grooves m2, thereby forming the punching die 17, the blade members are supported by three regions whose densities are high; i.e., the near-surface regions and the central region of the die substrate 32. Therefore, the blade members can be more stably supported.

Furthermore, since the blade members are supported by three regions whose densities are high, even when external forces act on the blade members as a result of repeated operation of punching out the sheet material 18, in the intermediate regions, wood fibers having burned and charred are not compressed by the blade members, and no gaps are formed between the blade members and the wall surfaces of the grooves m2. Thus, the blade members can be reliably supported. Therefore, the cutting edges 24a and 25a do not wobble, and thus, it is possible to stably punch out the sheet material 18 and stably form rules on the sheet material 18. As a result, punching accuracy can be improved.

In the present embodiment, the die substrate 32 is formed by two molded boards Pj. However, the die substrate 32 may be formed by bonding together three or more molded boards Pj by using the adhesive 35. In this case, since the number of central regions becomes two or more, the blade members can be more stably supported.

In the present embodiment, the MDF is used the molded board Pj. However, there can be used a particle board formed by fragmenting raw material chips into small pieces, mixing the small pieces with adhesive, and performing the thermo-pressure process on the resultant mixture, thereby forming the resultant mixture into a plate shape.

The present invention is not limited to the above-described embodiment. Numerous modifications are possible in light of the spirit of the present invention, and they are not excluded from the scope of the present invention.

### DESCRIPTION OF SYMBOLS

17: punching die
24: punching blade
25: rule-forming blade
32: die substrate
35: adhesive
m2: groove
Pj, Pj: molded board

1. A punching die comprising:
(a) a plurality of wood molded boards each formed by performing a thermo-pressure process on wood chips at a predetermined temperature and under a predetermined pressure;
(b) adhesive disposed between the stacked molded boards for bonding together to compose a die substrate; and
(c) a blade member press-fitted into a groove formed in the die substrate by means of laser machining such that the groove penetrates through the die substrate, wherein
(d) in the die substrate, densities of near-surface regions composed of regions located near opposite surfaces of the die substrate and a density of a central region composed of regions located adjacent to each other with the adhesive intervening therebetween are higher than densities of intermediate regions located between the near-surface regions and the central region.

2. A punching die according to claim 1, wherein each of the molded boards is composed of an MDF.

3. A punching die according to claim 1, wherein the adhesive is a foaming adhesive which is high in heat resistance and elasticity.

4. A punching die according to claim 1, wherein the intermediate regions of each of the molded boards has a density of 460 kg/m³ to 720 kg/m³, inclusive.

5. A punching die according to claim 1, wherein the molded boards are covered with a surface member.

6. A punching machine comprising a punching die according to claim 1.

7. A punching machine comprising a punching die according to claim 2.

8. A punching machine comprising a punching die according to claim 3.

9. A punching machine comprising a punching die according to claim 4.

10. A punching machine comprising a punching die according to claim 5.
